(19) United States
(12) Patent Application Publication
(10) Pub. No.: US 2025/0207710 A1
(43) Pub. Date: Jun. 26, 2025

(54) Heated Liner Systems for Thermal Protection of Processes and Process Instrumentation

(71) Applicant: Terrapin Industrial, LLC, Houston, TX (US)

(72) Inventors: Brad Faseler, Houston, TX (US); Daniel Tagtow, Austin, TX (US); Matthew Nance, Boling, TX (US); James E. Bundschuh, Fenton, MO (US)

(73) Assignee: Terrapin Industrial, LLC, Houston, TX (US)

(21) Appl. No.: 18/974,354

(22) Filed: Dec. 9, 2024

Related U.S. Application Data
(63) Continuation-in-part of application No. 18/974,322, filed on Dec. 9, 2024.
(60) Provisional application No. 63/614,206, filed on Dec. 22, 2023.

(51) Int. Cl. F16L 53/35

(52) U.S. Cl. CPC F16L 53/35

(57) ABSTRACT

Insulation and heating devices and systems are provided that may also function as a enclosure/container which heats and insulates a volume within the device. The device(s) provide volumetric constraints designed to hold fluids and/or processes that could freeze or become unstable in cold environments. The importance of maintaining a temperature above freezing on the interior of an enclosure containing instruments, sensors and instrument manifolds, including wetted parts of the system that carry the process streams, can be extremely critical. In all cases the method of mounting an insulated and heated liner system which includes heater cables being routed in a way to uniformly heat the entire internal skin area of a rigid or semi-rigid housing is also critical. The goal of the devices methods and systems is to properly hold heat in and eliminate heat loss that naturally occurs for heating enclosures filled with instrumentation in cold conditions.

### PRIORITY

This application is a continuation-in-part of U.S. Nonprovisional application Ser. No. 18/974,322 filed Dec. 9, 2024, which is a nonprovisional conversion of and claims priority to U.S. Provisional Application 63/614,206 filed Dec. 22, 2023, entitled “Insulation System for Process Instrument Enclosures That Provide Heating and Cooling”, the entirety of which are incorporated by reference herein.

### INTRODUCTION

In various industries such as petrochemical, refining, food processing, and gas compression, remote-mounted process instrumentation often requires an effective heat source to prevent freezing in wet fluid sections like piping, valves, and tubes enclosed in insulation. Failure to maintain adequate temperature can lead to the loss of process monitoring capabilities and potential shutdowns of critical utilities, including power generating stations and chemical processing plants.

Current practices for use of these liners often involve rigid enclosures for heaters, which complicate installation, maintenance, and replacement of components due to the crowded space within the enclosure. Additionally, existing heating methods, including electric heating cables or hot process fluid, pose burn risks to personnel. The invention addresses these issues by implementing a heated liner system that securely houses heating elements within a rigid conductive shell, insulated from personnel contact.

Recent climatic changes, including polar vortex storms, have increased the necessity for effective freeze protection in regions not traditionally subject to freezing temperatures. The current solutions often fail to provide adequate protection, necessitating a design that is adaptable for both new and existing installations.

### BACKGROUND

In the case of power generation, refining, chemical and plastics production, LNG and other gas production, compression systems, food and beverage, and other process applications, insulated instruments with heaters inside of enclosures are frequently employed to perform a function or fulfill a purpose. Such insulated instrument enclosure installation contains many components that must all be configured and mounted inside of the enclosure without interference with adjacent components. Often, these insulated instrument enclosures with heaters are installed in the field, and sometimes they are installed in a factory setting allowing for a more standardized installation from one enclosure system to the next. When using a factory for either pre- or full-assembly, field instrumentation and all other components that are mounted inside of the enclosure are usually purchased and shipped to the factory destination. This procedure can often create supply chain issues and delays field installation schedules leading to added costs. This often also results in remobilization of installation contractors once the fully assembled enclosure systems are shipped from the installation factory to the final jobsite. This is a very common practice in the industry today and requires complicated scheduling of parts and pieces to be assembled. In addition, along with the shipping costs of the fully assembled heated enclosure systems back to the jobsite, ineffective use of onsite manpower to install the heated enclosure systems so that the instruments can be calibrated and commissioned properly, there is a need for simplifying, cost reducing, and optimizing both the heating and insulation enclosures and the system for filed installation. The present disclosure further simplifies the installation performed in the field by eliminating the costly integration currently utilized by other enclosure manufacturers. Additionally, this disclosure provides for heating systems to be added to existing process facilities where temperatures below freezing are common or even unexpected. In much of the southern part of the United States, many power plants and other operating facilities were designed for ambient temperatures just above or barely below freezing.

Oftentimes, if a freeze did occur, the freezing temperatures would only last for a few hours, which did not put the processes at risk, and often times these warmer climates did not require any heating to protect the instrument and process stream systems. In recent years, several polar vortex storms have caused multi-day freezing events, which now put most of these plants at risk.

Summarizing, rigid enclosures with heaters are employed to prevent freezing, but this approach presents several challenges:
Complexity of Installation: Mounting components within a rigid enclosure is complex, often requiring intricate arrangements and the use of various brackets.
Maintenance Challenges: Replacing or maintaining heaters in confined spaces can be extremely difficult due to interference from other components.
Inadequate Design for Extreme Weather: Many installations were not designed for extreme cold conditions, leading to increased vulnerability during recent polar vortex storms.

Common practices involve applying electric heating cables or hot fluid tubing directly to process components. However, these methods pose risks:
Personnel Safety: Hot cables and tubes can cause severe burns, necessitating insulation where personnel might come into contact.
High-Temperature Risks: Using preferred cut-to-length heating cables can lead to failures when exposed to excessively high temperatures from main piping.

### SUMMARY

The present disclosure provides a heated liner blanket system that integrates heating elements within a rigid conductive shell. This shell is insulated and wrapped in an outdoor-rated protective material, ensuring both safety and efficiency. The heated liner system effectively distributes heat evenly across the internal surface, mitigating the risk of freezing in process streams.

The system allows for the easy routing of heating cables, minimizing installation complexity and facilitating maintenance without the need for complete disassembly of components. This design ensures that critical instrumentation remains operational even in extreme cold, thereby protecting essential infrastructure from unexpected shutdowns.

In the petrochemical, refining, food processing, gas compression, and gas processing industries, process instrumentation is often remote-mounted and requires heating to prevent freezing in cold climates. Freezing can disrupt the monitoring of process parameters, leading to significant operational risks, including the shutdown of power plants and chemical processing facilities.

Current practices often involve rigid enclosures for heaters, which complicate installation, maintenance, and replacement of components due to the crowded space within the enclosure. Additionally, existing heating methods, including electric heating cables or hot process fluid, pose burn risks to personnel. The invention addresses these issues by implementing a heated liner system that securely houses heating elements within a rigid conductive shell, insulated from personnel contact.

Recent climatic changes, including polar vortex storms, have increased the necessity for effective freeze protection in regions not traditionally subject to freezing temperatures. The current solutions often fail to provide adequate protection, necessitating a design that is adaptable for both new and existing installations.

The present invention provides for a heater system that is either field or factory-mounted in a rigid or semi-rigid enclosure and provides protection from ambient conditions as well as heat management. The disclosed heated liner system, which can be field or factory mounted, offers a protective enclosure and effective heat management. The heater cable is strategically secured to ensure optimal heating without occupying valuable space within the enclosure.

The proposed heated liner system integrates heating apparatus within a rigid, conductive material, which is wrapped with insulation and an insulated blanket. This design allows for safe access to instrument systems without exposing personnel to heating elements.

Some key features for this system include;
1. Protection from Burns: The insulation prevents personnel from contacting hot surfaces.
2. Enhanced Heat Management: By relocating heating cables to a protected liner, the system avoids damage from extreme temperatures and reduces risks of melting.
3. Improved Insulation: The complete enclosure ensures no heat is lost, maintaining necessary temperatures to prevent freezing
4. The invention provides a heated liner blanket system that integrates heating elements within a rigid conductive shell. This shell is insulated and wrapped in an outdoor-rated protective material, ensuring both safety and efficiency. The heated liner system effectively distributes heat evenly across the internal surface, mitigating the risk of freezing in process streams.
5. The system allows for the easy routing of heating cables, minimizing installation complexity and facilitating maintenance without the need for complete disassembly of components. This design ensures that critical instrumentation remains operational even in extreme cold, thereby protecting essential infrastructure from unexpected shutdowns.

### BRIEF DESCRIPTION OF THE DRAWINGS

The figures illustrate various components and illustrations of the disclosed lined heater and insulation system.

FIG. 1 provides an top perspective view of the heated liner system for use with valves, or other types of equipment that require an optimally maintained temperature range, where the rigid insulated body is rectangular and adapted to fit the size of the items enclosed.

FIGS. 1A-1F illustrate the components of the heated liner system as fitted for a valve.

FIG. 2 presents an exploded view of the heated liner system for use with instrumentation, where the rigid insulated body is adapted to fit the shape and size of the items enclosed.

FIG. 3 provides a partially exploded view of the heated liner system as used with batteries, or other types of equipment that require an optimally maintained temperature range, where the rigid insulated body is cuboid and adapted to fit the size of the items enclosed.

FIG. 4 provides a partially exploded view of the heated liner system where the rigid insulated body is cuboid shaped and provides access for heat trace cables and other cabling or tubing.

FIG. 5 provides a partially exploded isometric view of the top casing of a heated liner system utilizing a customizable drawn rigid conductive shell shown in the top side perspective;

FIG. 5A illustrates the drawn rigid conductive shell having separate welded tabs for heating element attachment.

FIG. 5B illustrates the drawn rigid conductive shell utilizing separate welded tabs for heating element attachment(s).

FIG. 5C provides a cross-sectional view of the right bottom casing segment of a heated liner system utilizing a rigid conductive shell, either drawn or stamped, with a molded insulation layer;

FIG. 6 provides a partially exploded isometric view of the top casing of a heated liner system utilizing a customizable stamped rigid conductive shell from a top side perspective;

FIG. 6A provides a surface view of the interior liner cover forming the internal housing surface of the heated liner system.

FIG. 6B illustrates the stamped rigid conductive shell having cut and bent tabs for one or more heating element attachment(s).

FIG. 6C illustrates the stamped rigid conductive shell utilizing cut and bent tabs for heating element attachment(s).

FIG. 6D illustrates an interior view of the stamped rigid conductive shell with mounting tabs.

FIG. 6E provides an illustrative view of a partially assembled top casing utilizing a stamped rigid conductive shell mounted to the interior liner cover.

FIG. 6F provides a close-up view of a partially assembled top casing of a heated liner system mounted to the interior liner cover and top casing having front latches.

FIG. 6G provides a close-up view of a partially assembled top casing of a heated liner system mounted to the interior liner cover and top casing having rear hinges.

FIG. 7 provides a cutaway illustration of the stamped rigid conductive shell of the heated liner system, showing the fitting of each heated liner system component through the last interior edge(s).

FIG. 8 provides an illustration of the drawn rigid conductive shell of the heated liner system, showing one of many arrangements that provide fitting of each component within the top casing.

FIG. 9 provides an exploded view of the heated liner system for use with batteries, or other types of equipment that require an optimally maintained temperature range, where the rigid insulated body is rectangular and adapted to fit the size of the items enclosed.

FIG. 10 depicts a soft-bodied embodiment of the heated liner system.

### DETAILED DESCRIPTION

The present disclosure allows for a simple retrofit to existing installations where there was no existing need for heating and insulation of the instruments, instrument manifolds and sensors and/or the instrument fluid stream that provides the overall installation system.

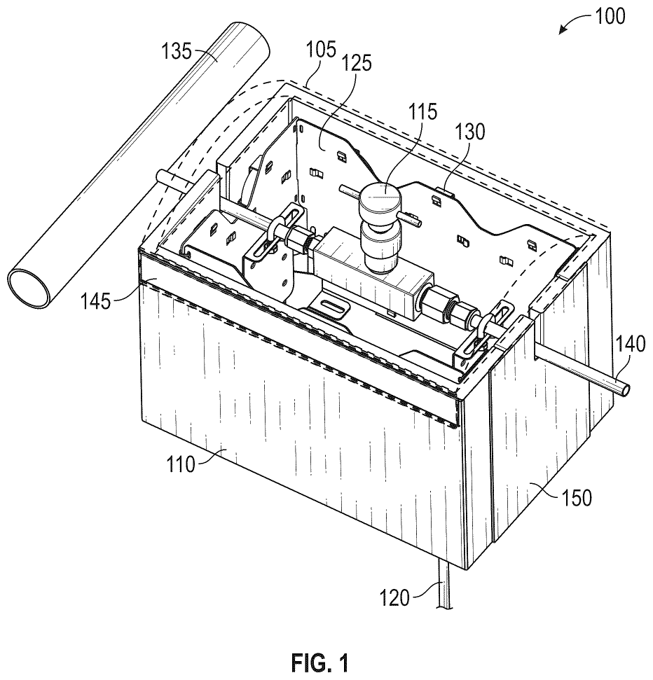

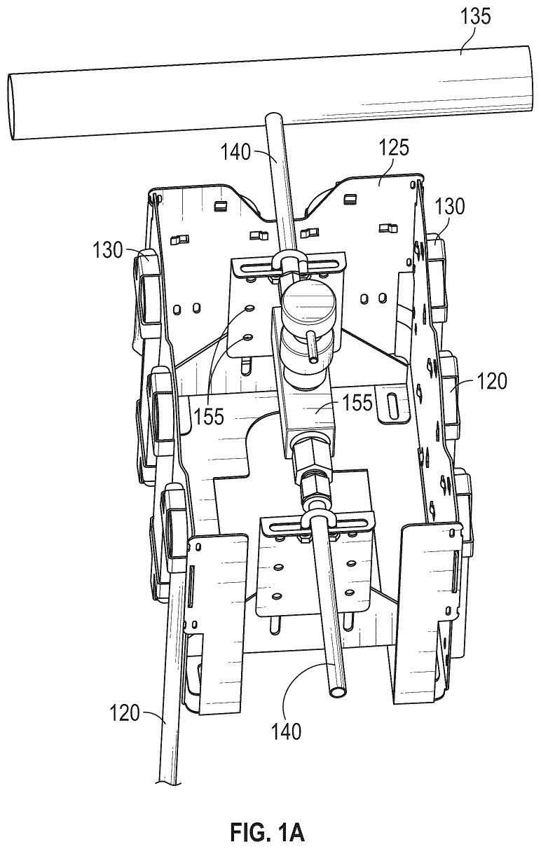

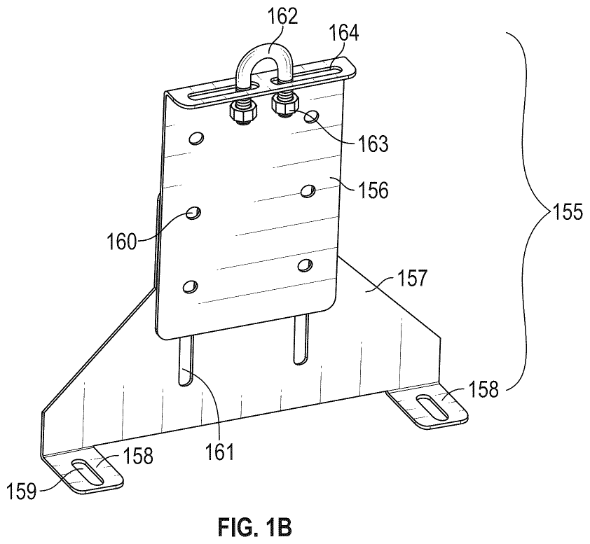

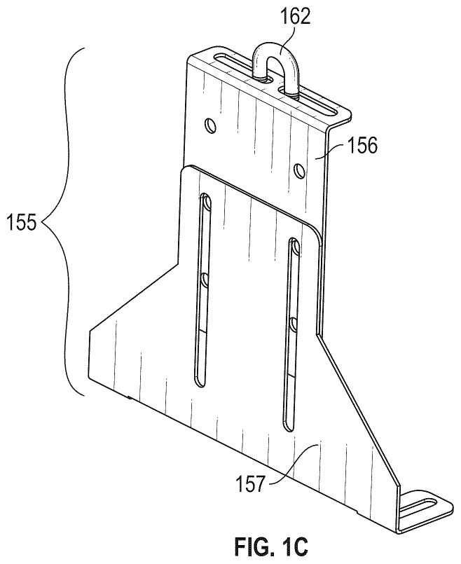

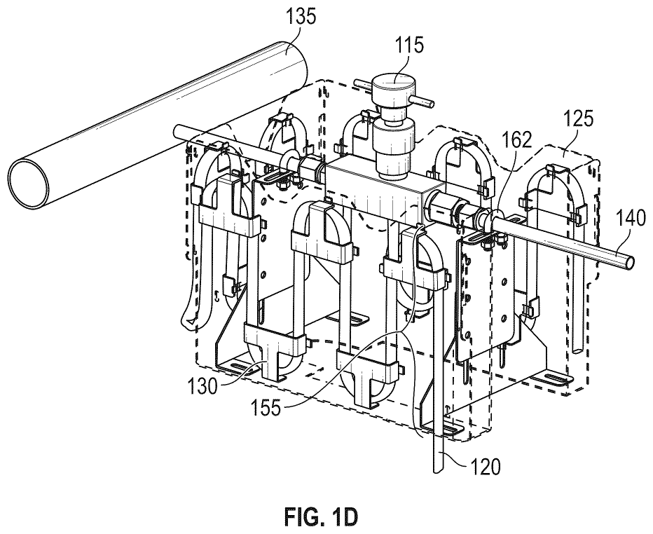

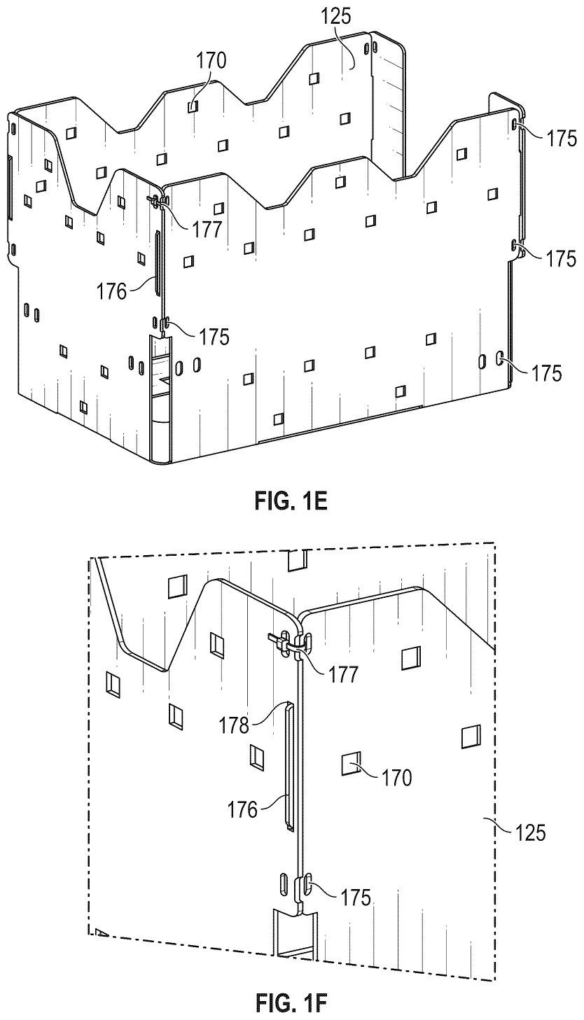

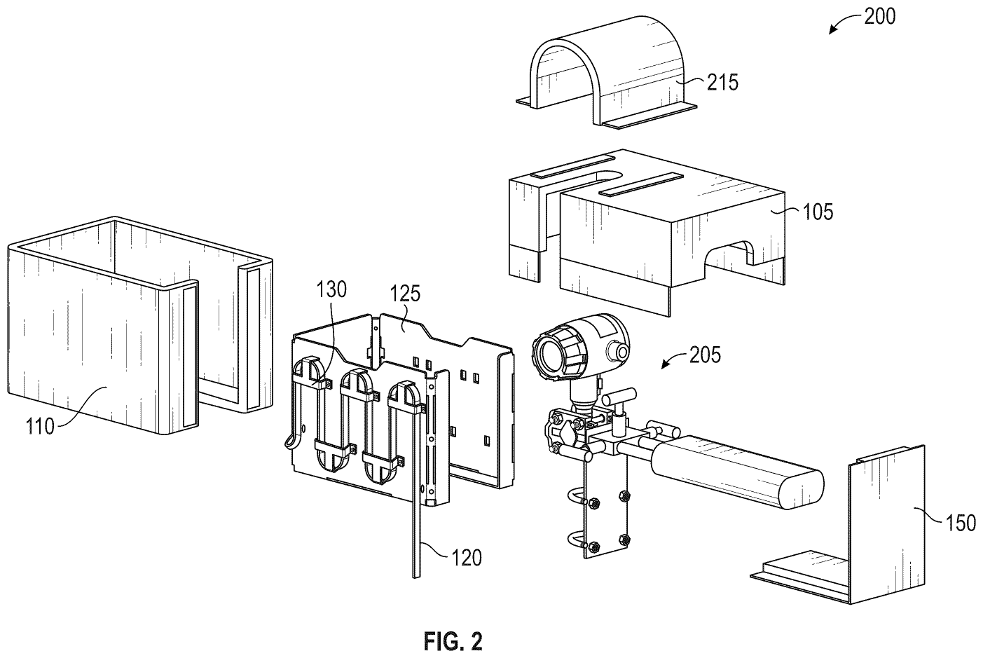

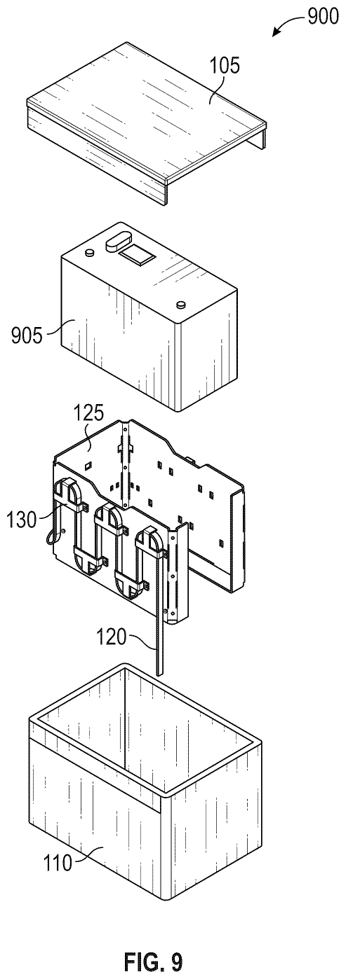

The heated liner system [100] of FIG. 1 consists of an insulated top section [105] and an insulated bottom section [110], where the insulated top and bottom sections [105, 110] fit together making an insulated body that is able to maintain thermal stability in order to protect a valve [115], instrument, equipment, components or other items (shown in FIG. 2) or a battery (shown in FIG. 9) contained within. The heated liner system employs heating elements [120] such as electric heating cables or heated fluid tubing (such as steam or hot oil) applied to a rigid conductive shell [125], which generates sufficient heat to maintain operational or process temperatures above freezing. The rigid conductive shell [125] is designed to hold the heating elements [120] securely in place with heating element routing tabs [130].

The heating element routing tabs [130] positions the heating element [120] at an engineered length and spacing to provide heating over a much larger area, therefore eliminating cold spots that pull heat away from the insulated body. The convection heating created by the heated liner system [100], in conjunction with the various insulation types, allows for a very flexible design to meet temperature requirements from the most critical cold arctic-like conditions or any condition requiring the item inside of a housing to be kept at a temperature above freezing.

The heated liner system is designed for easy retrofitting to existing installations that previously lacked adequate freeze protection, addressing the increasing frequency of freezing events in previously warm climates. The configuration is preferably U-shaped, allowing for unobtrusive mounting beneath instruments, valves, or tubing systems. The heating elements [120] are externally jacketed within an insulated blanket (that consist of flexible fabrics such as a thermally conductive fiberglass heat-insulating fabric (shown as the insulated top section [105] and the insulated bottom section [110], or encapsulated with a multi-layer insulation system, which is designed to retain heat and prevent loss through convection and increase personnel safety by minimizing exposure to hot surfaces and preventing burns.

The present embodiment shown in FIG. 1 provides for the heated liner system [100] for an isolation valve [115], where the isolation valve [115] is a root valve, which is first valve in the process line between the main process pipe [135] and an instrument (not shown). Sampling tubing [140], also referred to as impulse tubing, connects the valve [115] to the main process pipe [135] via a transition point, and allows for sampling and analysis of process fluid(s).

The process liquid or hot steam that is pulled from the main piping system goes to the isolation (root) valve [115]. The piping of the main system is stepped down in size from 3-inches to a ½-inch stainless steel sampling tubing [140], which then takes the fluid or other process stream to the process instrument(s) (not shown). The main piping process stream can be extremely hot, and often times exceeds the temperature limitations of common heating elements, such as common heating cables and preferred cut to length heating cables. To ensure these heating elements do not get melted, causing failure, the heating elements are removed off the pipe and placed on the rigid conductive shell [125] and insulated from the operating heat of the process.

The heated liner system [100] can be pre-assembled or easily configured in the field, simplifying installation processes and reducing labor costs. The design facilitates simple and provides ease of use replacement of heating elements [120] without disrupting the entire assembly.

The insulated top section [105] and the insulated bottom section [110] are securely attached to each other using a fastener [145] consisting of strips that include hooks and loops that are fabricated from flexible materials which are similar to a Velcro® type attachments and allow the sides of the insulated top section [105] to overlap the insulated bottom section [110] to create a sealed internal space that is thermally controlled.

The insulated top section [105] can have a flat top surface, domed top surface, or any shape or shape combination that provides room for the items housed within to be completely sealed within. For the valve embodiment of FIG. 1, the insulated top section [105] is provided with a domed shape. An insulated side section [150] is incorporated as part of the insulated body when features of the item within require entrance and exit from the insulated body.

FIG. 1A provides the internal components of a heated liner system [100] where, using sampling tubing [140], an isolation valve [115] branches off the main process pipe [135] and is supported within a rigid conductive shell [125], designed to hold the heating elements [120] securely in place with heating element routing tabs [130] using a set of support brackets [155] to hold the isolation valve [115] at a proper position within the heated liner system [100] so that conductive heating can occur. The rigid conductive shell [125] is designed to hold the heating elements [120] securely in place with heating element routing tabs [130].

FIG. 1B and FIG. 1C illustrate the front view and rear view respectively of the support bracket(s) [155] of the heated liner system [100], constructed of a top bracket component [156] and a bottom bracket component [157], where the bottom bracket component [157] is triangular in shape and contains mounting tabs [158] with mounting apertures [159] for attachment to the base of the rigid conductive shell [125, not shown]. The top bracket component [156] is affixed to the bottom bracket component [157] through the top bracket apertures [160] being secured to the bottom bracket sliding aperture [161] using a fastening means, such as a nut and bolt (not shown), where the height of the top bracket component [156] is adjustable to the height of the sampling tubing [140] depending on the vertical location of the fastening means on the bottom bracket sliding aperture [161]. A U-shaped bolt [162] with threaded nuts [163] is used to secure the isolation valve [115] to the top bracket component [156] of the support bracket(s) [155] using instrument mounting apertures [164], having the ability to accept various widths of a U-shaped bolt [162].

FIG. 1D provides the positioning of the support bracket(s) [155] within the rigid conductive shell [125]. The support brackets [155] are employed as support for the sampling tubing [140] of the isolation valve [115] off the main process piping [135], which is secured to the support bracket(s) [155] with U-shaped bolt(s) [162]. The support bracket(s) [150] also maintain the position of the heating elements [120] of the heated liner system [100] around the isolation valve [115] so as to keep the valve [115] from experiencing hot-spots, extreme process heat, thermal degradation of components, or other types of overheating, or alternatively from malfunctions or shutdowns caused by under-heating or freezing of the process streams or components.

FIG. 1E provides an embodiment of the rigid conductive shell [135] having a rectangular shape, and stamped or cut for routing tab apertures [170], allowing for attachment of the heating element routing tabs [130], and with corner slots [175] and support tabs [176] (for fitting with the support slots, shown as [178] in FIG. 1F) for the maintaining of structural integrity and shape. The corner slot [175] is secured with a zip-type fastener [177]. FIG. 1F illustrates a close-up view of the rigid conductive shell [125] fastened and secured in a rectangular shape.

FIG. 2 illustrates the heated liner system [100], in arrangement [200], shown fitted for an instrument, piece of equipment, or other item(s) [200] consists of an insulated top section [105] and an insulated bottom section [110], where the insulated top and bottom sections [105, 110] fit together making an insulated body that can be modified in shape to accommodate the housed item in order to maintain thermal stability and protect the instrument [205] contained within. For the arrangement [200] of the heated liner system [100], insulated side section [210] and insulated instrument section [215] are incorporated as part of the insulated body. The configuration is preferably U-shaped, allowing for unobtrusive mounting beneath instruments, valves, or tubing systems.

The heated liner system [100] in arrangement [200] employs heating elements [120] such as electric heating cables or heated fluid tubing (such as steam or hot oil) applied to a rigid conductive shell [125], which generates sufficient heat to maintain operational or process temperatures above freezing. The rigid conductive shell [125] is designed to hold the heating elements [120] securely in place with heating element routing tabs [130].

Arrangement [200] specifically illustrates a Heated Liner System [100] for Instruments or Impulse Root Valves off of a main pipe.

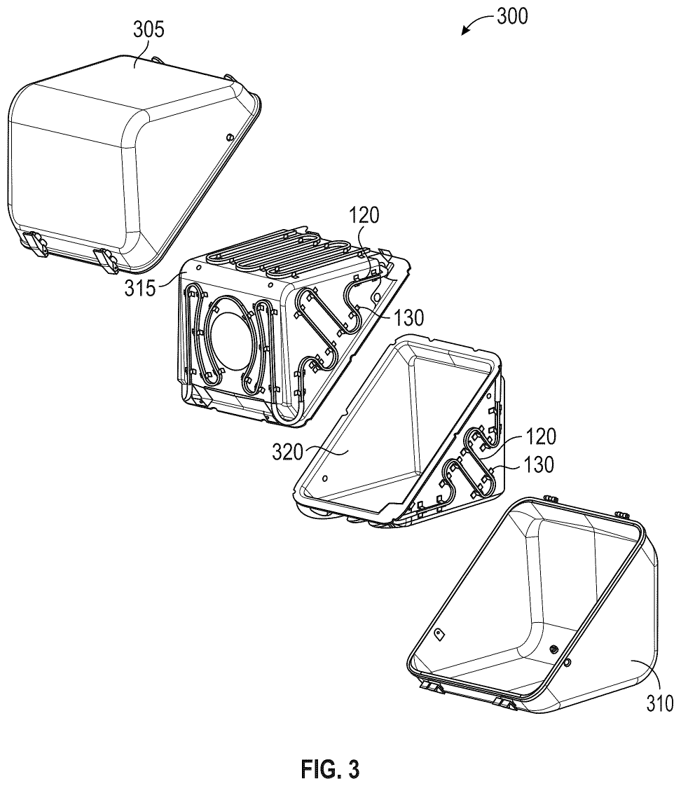

FIG. 3 provides the heated liner system [100] in arrangement [300] consists of an insulated hinged top section [305] and an insulated hinged bottom section [310], where the insulated hinged top and bottom sections [305, 310] fit together making a hinged insulated body that is able to maintain thermal stability in order to protect items contained within. The heated liner system [100] in arrangement [300] employs heating elements [120] such as electric heating cables or heated fluid tubing (such as steam or hot oil) applied to a top rigid conductive shell [315], and a bottom rigid conductive shell [320], which generates sufficient heat to maintain operational or process temperatures above freezing. The top and bottom conductive shells [315, 320] are designed to hold the heating elements [120] securely in place with heating element routing tabs [130]. The configuration is preferably half cuboid-shaped, allowing for full fitment within the insulated top hinged section [305] and the insulated bottom hinged section [310].

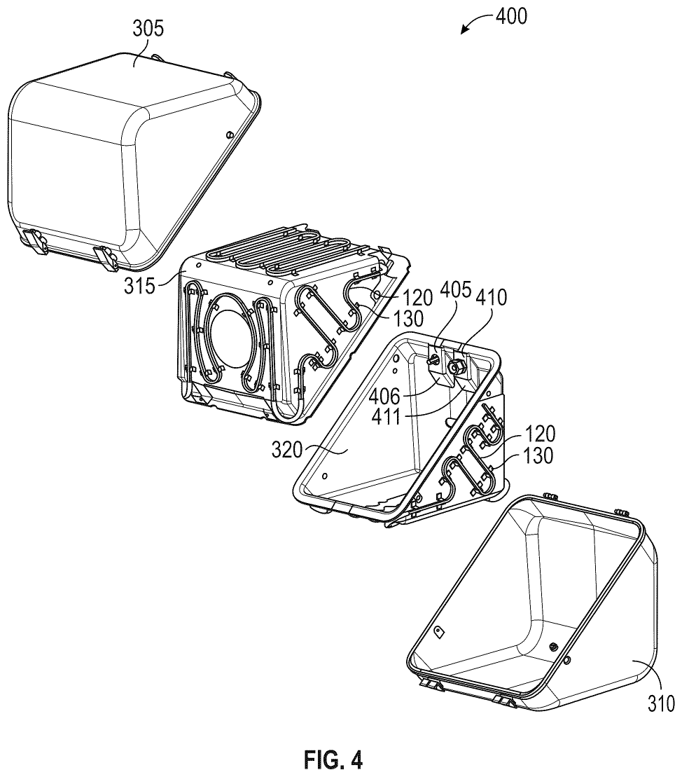

FIG. 4 provides the heated liner system [100] in arrangement [400] includes a heating element aperture [405] housed within a heating element exit [406] and a process aperture [410] housed within a process exit [411]. The heating element aperture [405] is a conduit that allows entrance of the heating elements [120] into the internal space of the insulated body, while the process aperture [410] allows entrance of process line tubing, power cables, or tubing/cable needs into the internal space of the insulated body. An optional conduit made of irradiated polyvinylidene fluoride (PVDF) or another suitable material for heating elements [120], such as heat cables, can be used in place of or in conjunction with the heating element aperture [405]. An example conduit is Convolex, made by Raychem. The heating element aperture [405] or optional conduit serves two purposes:
1). protecting the heating element, such as a heater cable, and
2). keeping the electrically charged heating element, such as a heater cable, from being easily accessed by an operator who may be working on the enclosures.

In one embodiment, the rigid conductive shell(s) [125,315,320] can be a drawn or stamped with strategically located heating element routing tabs [130] engineered to specific length and design.

The drawn shell will have the element routing tabs [130] welded to the rigid conductive shell [125,315,320]. The stamped shell will have the heating element routing tabs [130] stamped into the rigid conductive shell [125,315,320].

A liner system with heating element routing tabs welded to the liner eliminates holes in the rigid conductive shell. With the welded-on tabs to the liner, there will be no exposed heating element sections which might be required to add another internal liner if the user feels that the exposed heating element through the holes could be unsafe. When the heating element is secured to the liner using the tabs that are welded to the rigid conductive shell with no holes cut into the liner itself, providing a completely hidden heating element within the heated liner system.

The heating element [120] can be of various outputs, including at least 5 watt per foot, 10 watt per foot, 15 watt per foot, 20 watt per foot ranges.

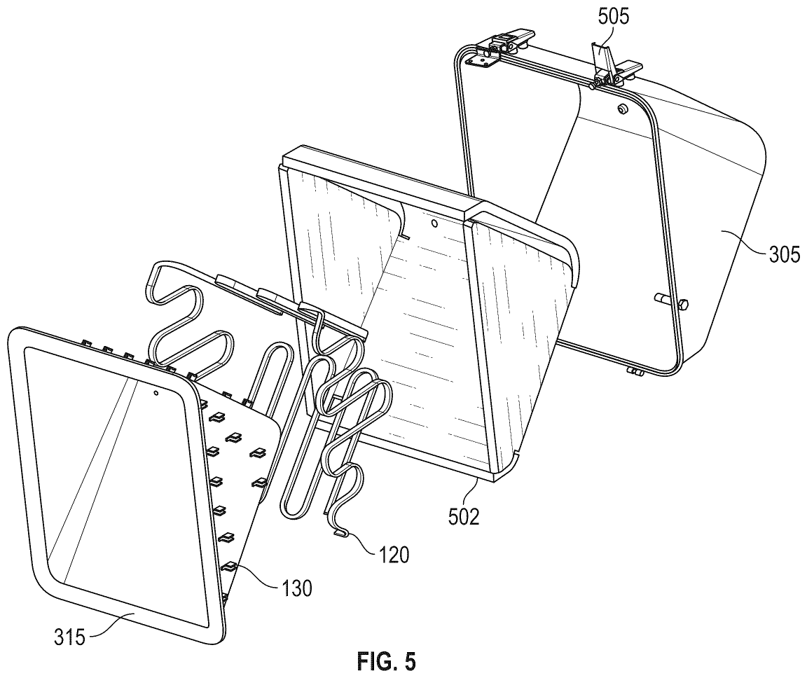

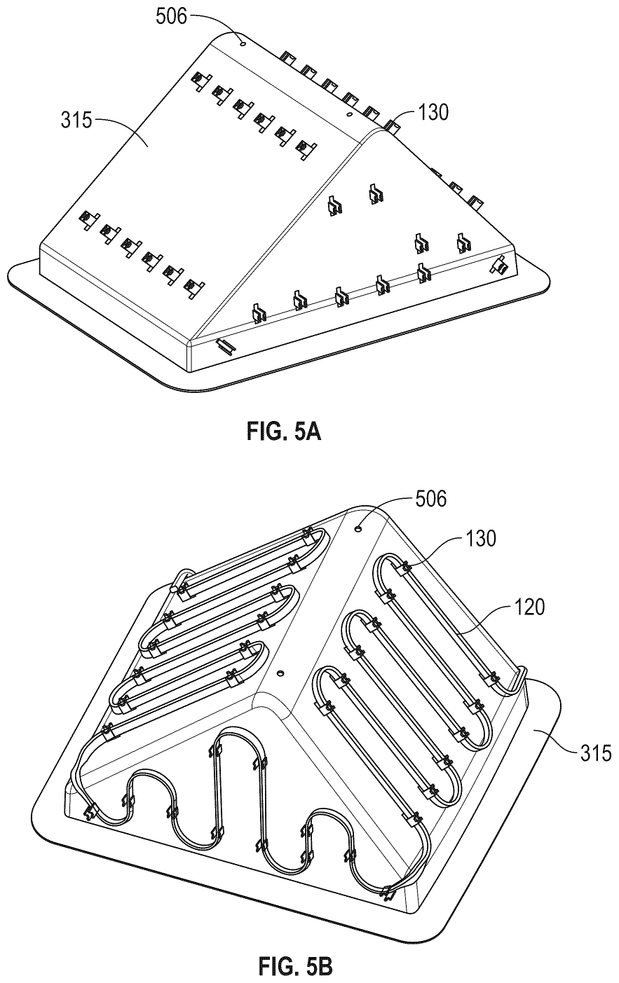

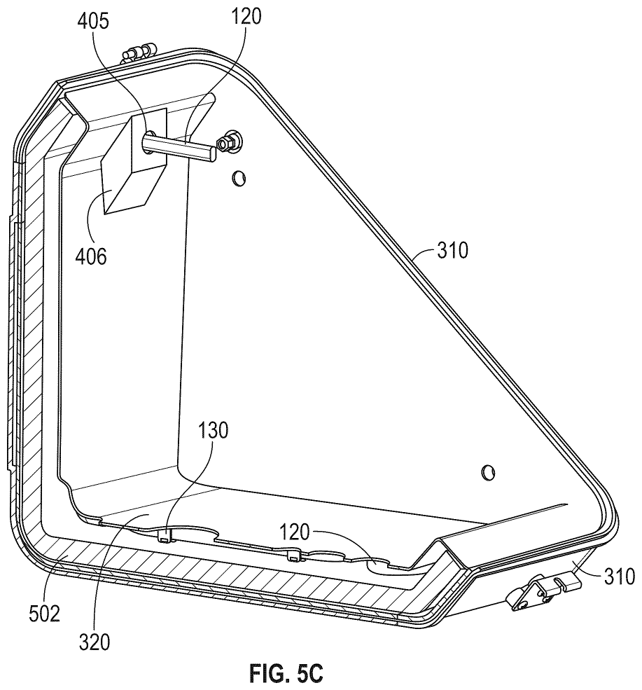

FIG. 5 provides a partially exploded isometric view of the insulated hinged top section [305] with a rigid conductive shell [315] of a heated liner system [100] in arrangement [300] from a top side perspective. The top portion of the heated liner system [100] is completed using the latched top section [305], top insulation liner [502], heating element [120] and the drawn rigid conductive shell [315] having welded heating element routing tabs [130]. A latching mechanism [505] is provided as a means of securing the insulated hinged top section [305] to the insulated hinged bottom section [310, not shown].

FIG. 5A and FIG. 5B provide the drawn rigid conductive shell [315] showing the heating element [120] and the heating element routing tabs [130] welded to the drawn rigid conductive shell [315] positioned at an engineered length and spacing to provide heating over a much larger area. Liner apertures [506] are included for affixing the drawn rigid conductive shell [315] to the top insulation liner [502] and the latched top section [305].

FIG. 5C provides a cross-sectional view of the right bottom casing segment [310] of a heated liner system [100] in arrangement [300,400] utilizing a bottom rigid conductive shell [320], either drawn or stamped, with a molded insulation liner [502], where the insulation liner [502] can be of varying type and thickness as needed by ambient climate demands.

The insulation liner [502] is a molded foam such as urethane or polyisocyanurate with notches in place to allow the heating element [120] to nest into the foam as to sit as flush into the enclosure as possible. Insulation half shell sections comprising of notched insulation to nest the heating element [120] into the bottom section of the enclosure, are fitted within the complete bottom casing [310].

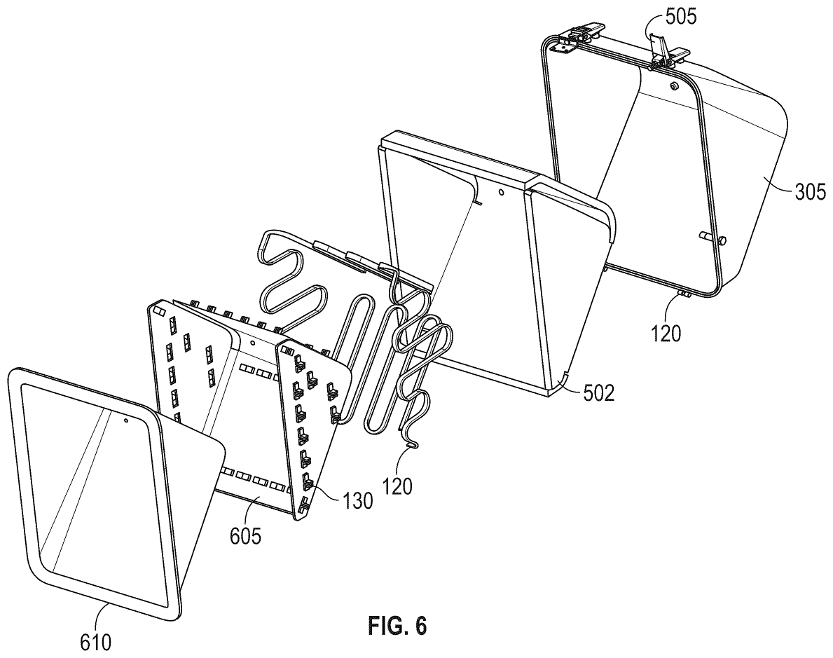

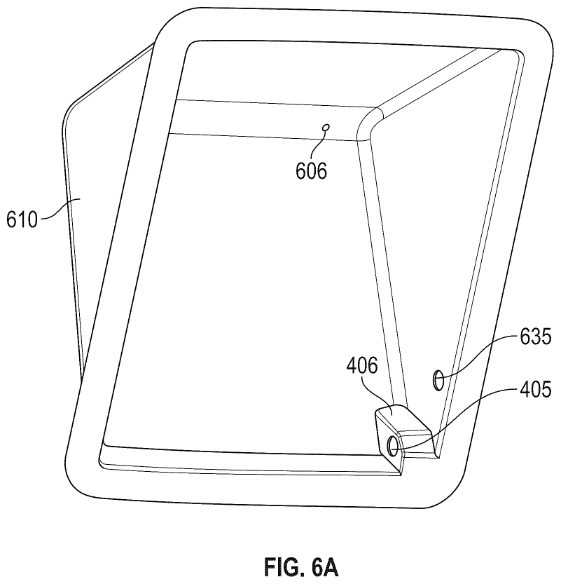

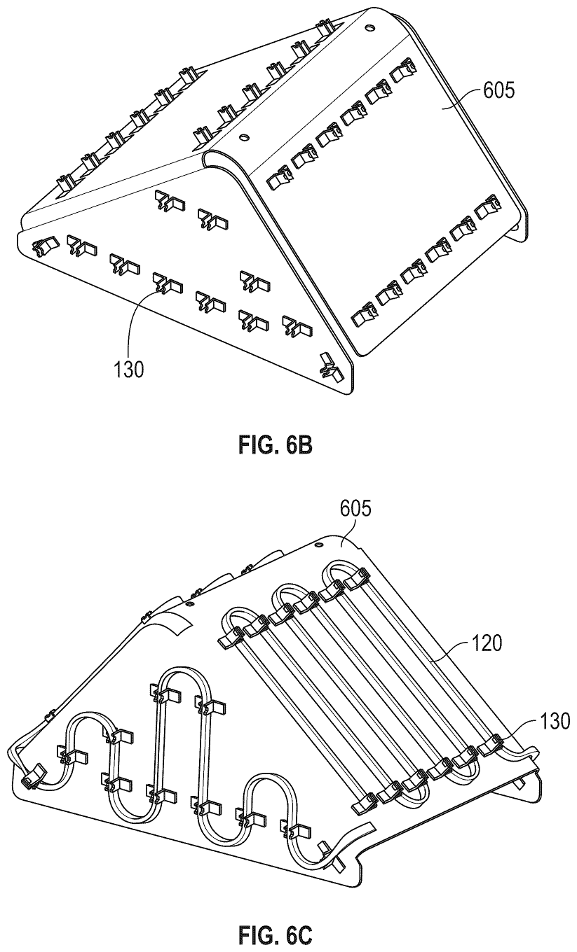

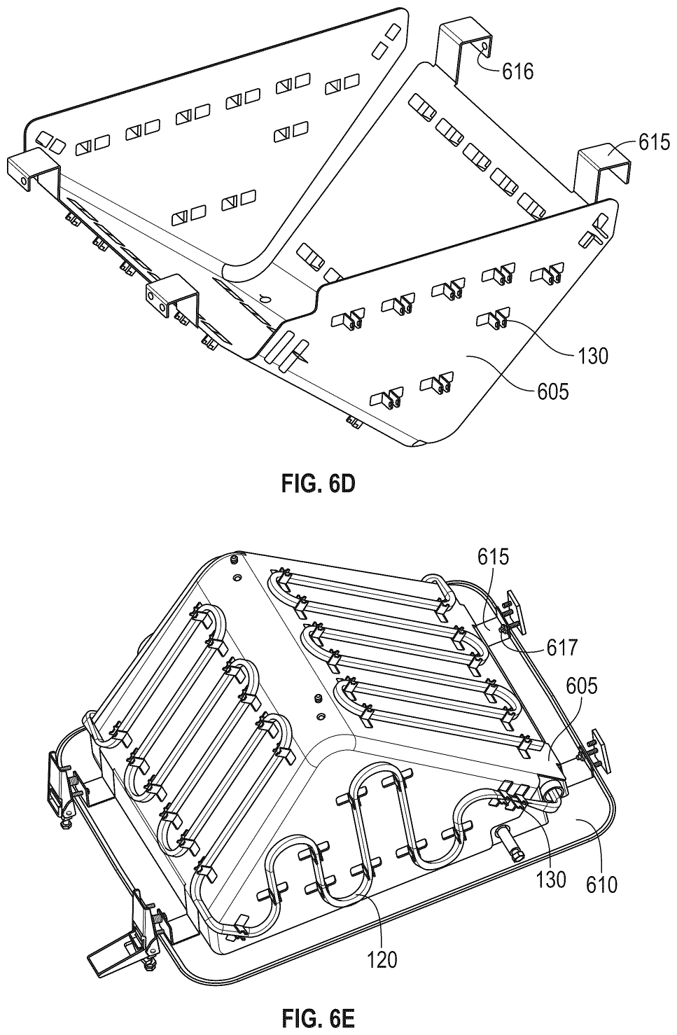

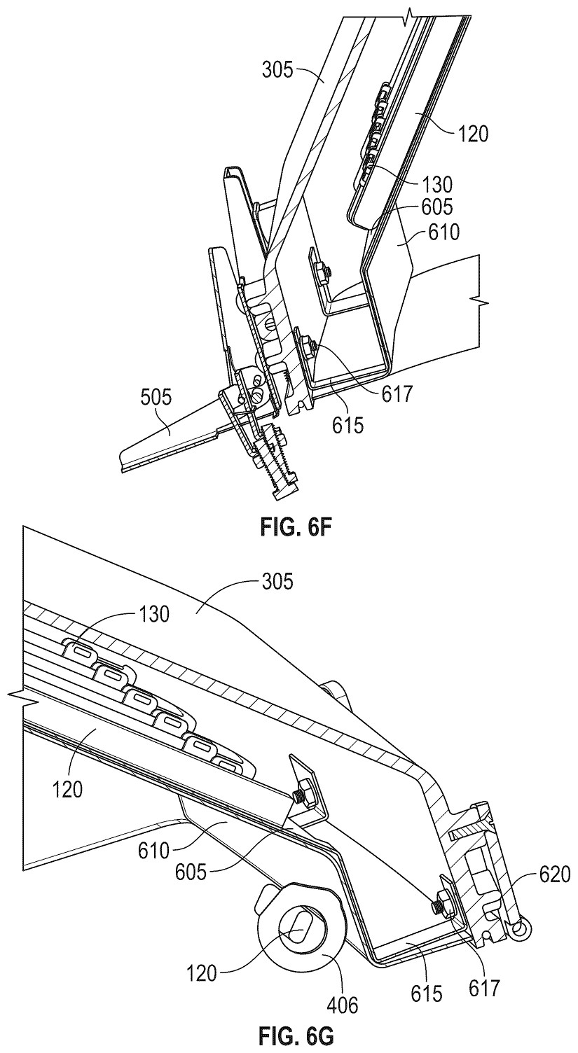

FIG. 6 provides a partially exploded isometric view of the insulated hinged top section [305] with a stamped rigid conductive shell [605] of a heated liner system [100] in arrangement [300,400] from a top side perspective. The heated liner system [100] having a stamped rigid conductive shell [605] is completed using the top casing [301], top insulation liner [502], heating element [120], the stamped top liner [605] with stamped heating element routing tabs [130] and the top interior liner cover [610]. A latching mechanism [505] is provided as a means of securing the insulated hinged top section [305] to the insulated hinged bottom section [310], as shown in FIG. 3 and FIG. 4. The top interior liner cover [610 ] is affixed to the stamped top liner [605], the top insulation liner [502], and insulated hinged top section [305]. The stamped top liner [605] is additionally affixed to the top interior liner cover [610].

FIG. 6A provides an interior surface view of the top interior liner cover [610] showing the smooth internal plastic surface capable of fitment within the insulated hinged top section [305] of the heated liner system [100]. Fastening features include openings [635] and liner apertures [606]. The heating element aperture [405] within the top heating element exit [406] provides protection to the heating element [120, not shown]. The top heating element exit [406] is positioned at the bottom right corner of the top interior liner cover [610] allowing the heating element [120] to remain in an optimal position for reduced interference with components of the enclosure and accidental interaction with the operator or maintenance personnel.

FIG. 6B and FIG. 6C depict the stamped top liner [605] showing the heating element [120], the heating element tabs [130] stamped out to create tabs or other mounting systems to add the heating element [120] at an engineered length and spacing to provide heating over a much larger area, therefore eliminating cold spots that pull heat away from the heated liner system [100]. The convection heating created by the heated liner system [100], in conjunction with the various insulation types will allow a very flexible design to meet temperature requirements from the most critical arctic conditions or any condition requiring the instrumentation mounted inside of an enclosure to be kept at a temperature above freezing.

FIG. 6D provides an underside view of the stamped top liner [605] with liner mounting tabs [615]. The liner mounting tabs [615] are used to secure, as needed, the stamped top liner [605] to the top casing [605] using mounting tab apertures [616]. The mounting tabs [615] are designed to have a wide J-hook feature to allow maximum widths of the insulation liner [502] while still allowing space for the mounting tab bolts [617], shown in FIG. 6E.

FIG. 6E illustrates a top view of the stamped top liner [605] affixed to the top interior liner cover [601] using liner mounting tabs [615] fastened with mounting tab bolts [617].

FIG. 6F illustrates a forward side cross-section stamped heated liner top assembly [100] of arrangement [300,400] with the top insulation liner [502] removed. Details of the latching mechanism [505] are shown, behind which the liner mounting tabs [615] of the stamped top liner [605] are fastened using mounting tab bolts [617] to the top casing [305]. Heating elements [120] are shown routed through the heating element routing tabs [130]. The top interior liner cover [610] closes the remaining gap created by the liner mounting tabs [615], in which the top insulation liner [502] resides, creating an adiabatic environment within the heated liner system [100], when the instrument enclosure, housing, or casing is in a closed position.

FIG. 6G illustrates a rearward side cross-section stamped heated liner system [100] with the top insulation liner [502] removed. Details of the hinge are shown, behind which the liner mounting tabs [615] of the stamped top liner [605] are fastened using mounting tab bolts [617] to the top casing [305]. Heating elements [120] are shown routed through the heating element routing tabs [130]. The top interior liner cover [610] closes the remaining gap created by the liner mounting tabs [615], in which the top insulation liner [502] resides, creating an adiabatic environment within the enclosure, housing, or casing, when in a closed position.

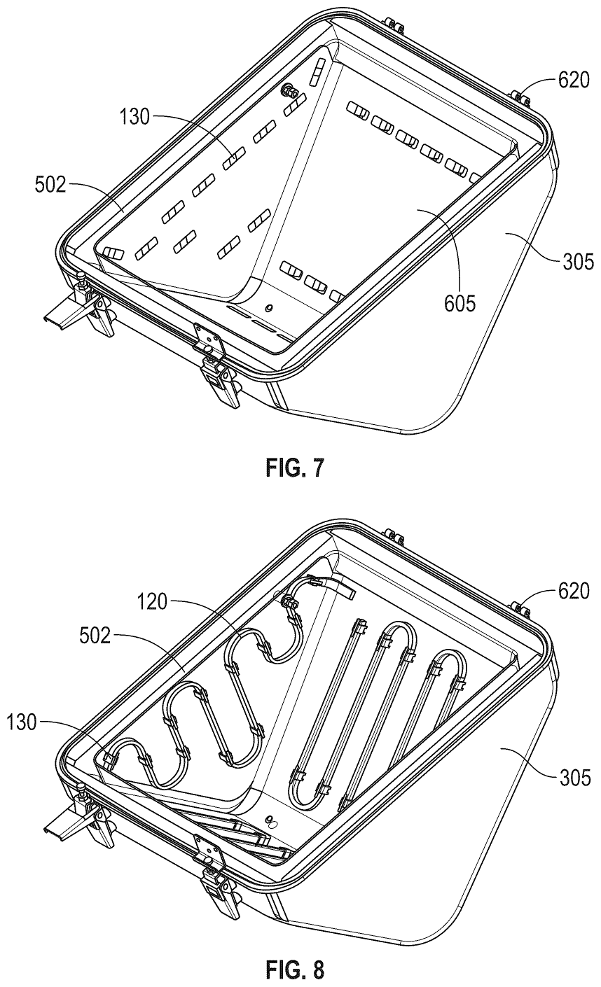

FIG. 7 and FIG. 8 provide cutaway illustrations of the top casing [305] utilizing a heated liner system [100]. FIG. 7 provides a cutaway illustration of the stamped heated liner system of the top casing, showing the fitting of each liner system component through the last interior liner edge(s) in order to provide a completed view of a stamped heated liner system [100] in

arrangement [300,400]. The top interior liner cover is not shown in order to provide the cutaway view of the remaining components.

FIG. 8 provides a cutaway illustration of the drawn heated liner system of the top casing, showing some optimal arrangements for fitting of each liner system component(s) through the last interior liner edge(s) in order to provide a completed view of a drawn heated liner system [100] of arrangement [300,400]. The top rigid conductive shell [315] is shown as a transparent component in order to show the routing of the heating element [120] through the heating element routing tabs [130] in a manner that maximizes the surface area of the routed heating element [120] within the top casing [305] of the heated liner system [100].

The heated liner system [100] includes an arrangement [900], shown in FIG. 9, consists of an insulated top section [105] and an insulated bottom section [110], where the insulated top and bottom sections [105, 110] fit together and create an insulated body that is able to maintain thermal stability in order to protect a battery [905] or other components contained within the heated liner system. The heated liner system [100] employs heating elements [120] such as electric heating cables and/or heated fluid tubing (utilizing steam or hot oil) applied to a rigid conductive shell [125], which generates sufficient heat to maintain operational or process temperatures above freezing. The rigid conductive shell [125] is designed to hold the heating elements [120] securely in place with heating element routing tabs [130].

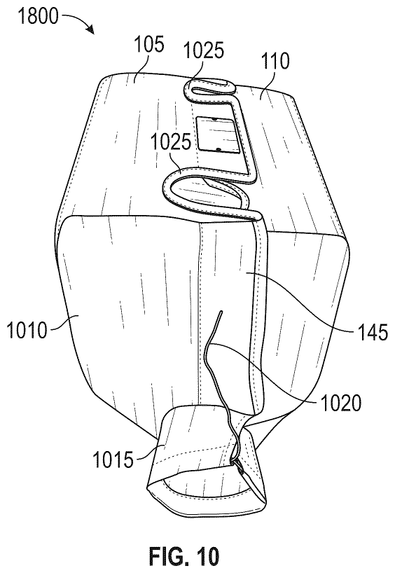

FIG. 10 depicts a soft-bodied embodiment [1000] of the heated liner system [100], where the outer covering of the system is a high-temperature resistant fabric [1010], secured by a fastener [145] consisting of strips of fiber hooks and loops that are similar to a Velcro® type of attachment means, allowing the sides of the insulated top section [105] to overlap the insulated bottom section [110] and to create a sealed internal space that can be thermally controlled. A flexible sleeve [1015] is provided with a drawstring [1020] to further secure the system from the external elements or process conditions, when a pipe or pipe stand (not shown) is utilized.

Customizable openings [1025] can be created based on the needs of the user for instrumentation or access.

This subject matter addresses problems that may arise with heaters used for insulated heated enclosures or insulated heating field installations with conventional insulated blankets typically used today. With respect to current rigid or soft blanket enclosures, there are numerous advantages as follows;

The present enclosures and accompanying methodology allows for the heater in the instrument blanket system to be mounted in such a way that it is integrated into the insulation system, and provides a systematic geometry that clears the pathway to allow not taking up any space inside of the working area of the enclosure. The benefit in this instance is to remove the risk of personnel coming into contact and potentially burning themselves when in handling the instrumentation or the enclosed areas or both. In addition, the preferred cut to length heating elements, such as heater cables, can often melt due to overtemperature caused by extremely hot process plant operating temperatures and this problem has been neutralized.

Additional benefits include enabling contractors to install equipment properly so that enclosures and blankets to existing installations that previously had no known temperature range requirements due to historical low ambient design temperatures and that would not have indicated a risk of freezing the process and shutting down the facility are now protected.

Time savings during original installation is increased as the disclosed heated liner system is reassembled so that only the heating element terminations need to be extended to the Multi-Point Power Connection box located just below the instrument on the pipe stand. It is also possible to extend the steam or other hot process fluid final connections being made to the plant steam hot oil, or other fluid heating system.

Also, the lined heater system will provide far superior watts output as compared to finned and block heaters. The engineered length (for many installations typically 20 ft of cable) will allow for up to 400 watts of heat to accommodate the maximum sized finned heater that can currently fit inside of an enclosure-which is 400 watts. This heater type would double the heat output while still removing the large heater and conduits from the inside volume designated real estate of the enclosure.

Additionally, the lined heater utilizes heating elements, such as heater cables, that come certified for hazardous areas with Auto Ignition Temperature ratings as low as T6 and as high as T2, providing a much more complete range of temperatures in which the disclosed lined heater can operate.

The lined heater system utilizes heating elements, such as heater cables, provided in a myriad of output ranges, depending on the manufacturer which allows the lined heater system to produce from 120 watts of output up to 800 watts of output. Even higher power outputs are possible by adding more heater cable to the liner if needed. The liner heater utilizes heater cables that are built to last 30+years in service. In contrast to traditional finned and block style heaters used today, that often fail in less than 5 years, leaving critical instrumentation at risk, which often shuts down power plants and other critical infrastructure, the present disclosure greatly reduces these risks.

The heated liner system also saves time and money in original installations and re-installations after maintenance with a simple replacement of the heating elements on the liner. This provides a more optimal system to maintain equipment within the enclosures. The liner heater can also be used for heating analyzer shelters as well as other enclosed spaces that are utilized by industrial and non-industrial processing facilities.

Further embodiments allow for the heating elements to be integral with the heated liner system by attaching the heating elements, such as heater cables, to tabs strategically placed on the liner so that the desired footage of heater cable and desired wattage output optimally meet the heat loss demands to keep the inside of the instrument from freezing. The entire liner heater assembly is simply woven into an insulated blanket such that the heater cable or heater tubing is “stubbing out” from the blanket to allow for attachment to electrical and/or hot fluid systems. Additionally, the heater provides both protection from personnel coming into contact with the heating elements as well as providing a protective buffer for the heating element when a preferred cut to length heater cable is utilized. This is especially required in areas where the process temperatures may exceed the limitations of the cable, making it difficult or impossible to utilize cut to length auto-regulating heating cables on high temperature processes.

The foregoing description and the accompanying drawings are provided to illustrate the invention and are not intended to be exhaustive or to limit the invention to the precise form disclosed. Numerous modifications and variations will be apparent to those skilled in the art without departing from the broader scope and spirit of the invention, which is defined solely by the claims. The claims should not be construed as limiting the invention to the specific embodiments described herein.”

We claim:

1. A heated liner system constructed from several components comprising:
a conductive shell configured to house heating elements that provide at least one insulated enclosure, wherein said insulated enclosure encases said conductive shell and wherein said heating elements are securely mounted within said conductive shell that provides homogenously distributed heat across at least one internal surface of a heated liner that exists within said conductive shell.

2. The heated liner system of claim 1, wherein said conductive shell is a rigid conductive shell.

3. The heated liner system of claim 1, wherein said conductive shell is a non-rigid conductive shell that is soft and possesses a blanket cover capability.

4. The heated liner system of claim 1, wherein said conductive shell is at least two components that when placed together comprises a complete insulated enclosure.

5. The heated liner system of claim 1, wherein said heating elements are selected from the group consisting of electric heating cables and heated fluid tubing.

6. The heated liner system of claim 1, further comprising heating element routing tabs integrated into said conductive shell for positioning heating elements at specific engineered lengths and spacing that are either preassembled or assembled on site and eliminate cold locations or cold spots within said conductive shells.

7. The heated liner system of claim 1, wherein said insulated enclosure(s) are constructed of multi-layer insulation materials that retain heat to prevent heat loss through convection.

8. The heated liner system of claim 1, wherein said entire assembly is designed to optimize and minimize installation and maintenance time such that access to said heating elements is accomplished without a requirement to provide complete disassembly of said components.

9. The heated liner system of claim 1, wherein said conductive shell is adapted for optimization of a retrofit to existing installations that would otherwise lack adequate freeze protection.

10. The heated liner system of claim 1, wherein said conductive shell allows a complete configuration to be mounted beneath instruments, valves, or tubing systems to ensure minimal interference with accessories to be mounted internal or external to said heated liner system.

11. The heated liner system of claim 1, wherein said heating elements rout tabs that prevent direct exposure of heating cables or tubing to personnel thereby reducing or eliminating any risk of burns.

12. The heated liner system of claim 1, wherein said system is rated for operational temperatures that maintain process temperatures above freezing even under extreme cold conditions.

13. The heated liner system of claim 1, capable of producing heating outputs that exist in a range from 120 watts to 800 watts wherein a configuration of heating elements used will dictate a possibility of operation at either a low end or high end of said range.

14. The heated liner system of claim 10, wherein a design of said complete configuration provides heating elements with an extended service life of at least 30 years that includes reduced failure rates lower than traditional finned or block heaters.

15. The heated liner system of claim 1, wherein installation time and labor costs reductions of said system is achieved so that pre-assembly and/or field configuration without removal of existing instrumentation that exists within said insulated enclosure.

16. The heated liner system of claim 1, wherein said liner system includes a protective outer layer that increases durability and functionality for outdoor installations.

17. The heated liner system of claim 1, further comprising apertures for entry of process line tubing and power cables to maintain integrity of said insulated enclosure.

18. The heated liner system of claim 1, wherein said conductive shell(s) are manufactured via either drawn or stamped processes to provide structural and thermal efficiency.

19. The heated liner system of claim 1, wherein personnel that operates in proximity to said heated liner system are shielded from direct contact with otherwise exposed heating elements.

20. The heated liner system of claim 1, wherein additional heating elements are attached as required that allow for increased wattage outputs required to reduce or eliminate specific heat loss demands at specific locations.
